(19) United States
(12) Patent Application Publication
(10) Pub. No.: US 2012/0188410 A1
(43) Pub. Date: Jul. 26, 2012

(54) IMAGING DEVICE

(75) Inventor: Yusuke OBATA, Osaka (JP)

(73) Assignee: Panasonic Corporation, Osaka (JP)

(21) Appl. No.: 13/196,849

(22) Filed: Aug. 2, 2011

(30) Foreign Application Priority Data
Jan. 21, 2011 (JP) 2011-011151
Apr. 5, 2011 (JP) 2011-083489

(51) Int. Cl. H04N 5/262

(52) U.S. Cl. 348/239; 348/E05.051

(57) ABSTRACT

An imaging device is provided that includes an imaging unit, an imaging condition mode setting unit, a crop region decision unit, a cropping unit, a display image data production unit, and a display unit. The imaging unit captures an image of a subject and generates image data. The imaging condition mode setting unit automatically sets any one of a plurality of imaging modes based on the image data. The crop region decision unit decides a region of the image data to be cropped according to the mode set by the setting unit. The cropping unit removes the image data from the region to be cropped and characterizes this region as cropped image data. The display image data production unit generates display image data of the cropped image data and sets the display image to a specific size. The display unit displays an image based on the display image data.

### CROSS-REFERENCE TO RELATED APPLICATIONS

This application claims priority to Japanese Patent Application No. 2011-011151, filed on Jan. 21, 2011, and Japanese Patent Application No. 2011-083489, filed on Apr. 5, 2011. The entire disclosure of Japanese Patent Application No. 2011-011151 and Japanese Patent Application No. 2011-083489 are hereby incorporated herein by reference.

### BACKGROUND

1. Technical Field

The technology disclosed herein relates to an imaging device.

2. Background Information

Most modern digital cameras come with a nighttime mode. If a digital camera has a nighttime mode, then in nighttime mode image data with a smaller angle of field is continuously cropped, as opposed to in other modes such when a person or a landscape is being imaged. The image data that are continuously cropped here are compared to each other, and camera shake is computed. The imaging region is then automatically corrected on the basis of this camera shake. Consequently, an image free of the effects of camera shake can be displayed on the monitor. JP-2006-229690 discloses a technique in which an image with a smaller angle of field is displayed in moving picture mode than in still picture mode.

With a digital camera such as that discussed above, if we assume that a nighttime mode is included in the mode of automatically determining the scene (scene determination mode), then there is the risk that a switch from nighttime mode to another mode, or from another mode to nighttime mode will be executed automatically. If there is an automatic switch between nighttime mode and another mode during imaging, the angle of field of the image will change on the liquid crystal monitor. As a result, the user could seem unnatural when the user looks the image on the monitor.

### SUMMARY

In view of the problem discussed above, one object of the technology disclosed herein is to provide an imaging device that can produce and display a natural-looking image.

Accordingly, an imaging device is provided that includes an imaging unit, an imaging condition mode setting unit, a crop region decision unit, a cropping unit, a display image data production unit, and a display unit. The imaging unit is configured to capture an image of a subject and generate image data. The imaging condition mode setting unit is configured to automatically set any one of a plurality of imaging condition modes based on the image data. The crop region decision unit is configured to decide a region of the image data to be cropped according to the imaging condition mode set by the setting unit. The region of the image data to be cropped is characterized as a crop region. The cropping unit is configured to remove the crop region from the image data. The crop region removed from the image data is characterized as cropped image data. The display image data production unit is configured to generate display image data of the cropped image data and to set the display image data to a specific size. The display unit is configured to display an image based on the display image data.

These and other features, aspects and advantages of the technology disclosed herein will become apparent to those skilled in the art from the following detailed description, which, taken in conjunction with the annexed drawings, discloses a preferred and example embodiments of the present invention.

### BRIEF DESCRIPTION OF DRAWINGS

Referring now to the attached drawings which form a part of this original disclosure:

FIG. 1 is a front view of the digital camera pertaining to an embodiment;

FIG. 2 is a rear view of the digital camera pertaining to an embodiment;

FIG. 3 is a block diagram of the digital camera pertaining to an embodiment;

FIG. 4 is a flowchart showing the flow of processing in a digital camera during imaging mode in an embodiment; and

FIG. 5 is a block diagram of the digital camera pertaining to another embodiment.

### DETAILED DESCRIPTION OF EMBODIMENTS

Selected embodiments of the present technology will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

In the discussion of the drawings that follows, portions that are the same or similar will be numbered the same or similarly. The drawings are merely schematics, however, and the dimension proportions and so forth may differ from those in an actual situation. Therefore, specific dimensions and the like should be concluded on by reference to the following description. Also, it should go without saying that the dimensional relations and proportions may vary from one drawing to another.

In the following embodiments, a digital camera will be used as an example of an imaging device. Also, in the following description, the direction facing the subject is defined as “forward,” the direction moving away from the subject as “rearward,” the vertically upward direction as “upward,” the vertically downward direction as “downward,” to the right in a state of facing the subject head on as “to the right,” and to the left in a state of facing the subject head on as “to the left,” all using the normal orientation of the digital camera (hereinafter referred to as landscape orientation) as a reference.

### First Embodiment

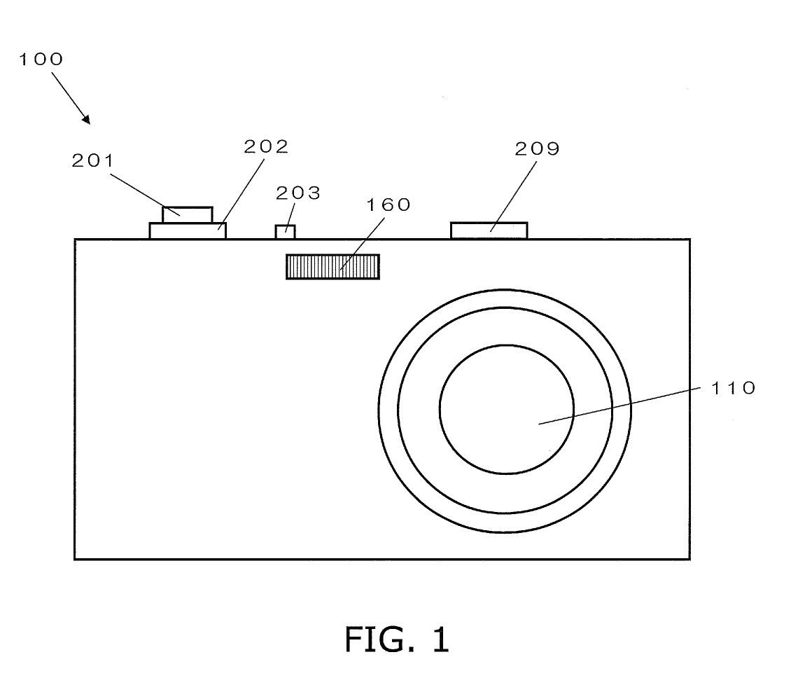

A digital camera 100 pertaining to an embodiment (an example of an imaging device) will now be described through reference to FIGS. 1 to 4. The digital camera 100 is an imaging device configured to capture both moving pictures and still pictures.

1-1. Configuration of Digital Camera

As shown in FIG. 1, the digital camera 100 is provided on its front face with a flash 160 and a lens barrel that houses an optical system 110. The digital camera 100 is provided with a manipulation unit 150 on its upper face. The manipulation unit 150 includes a still picture release button 201, a zoom lever 202, a power button 203, a scene switching dial 209, and so on.

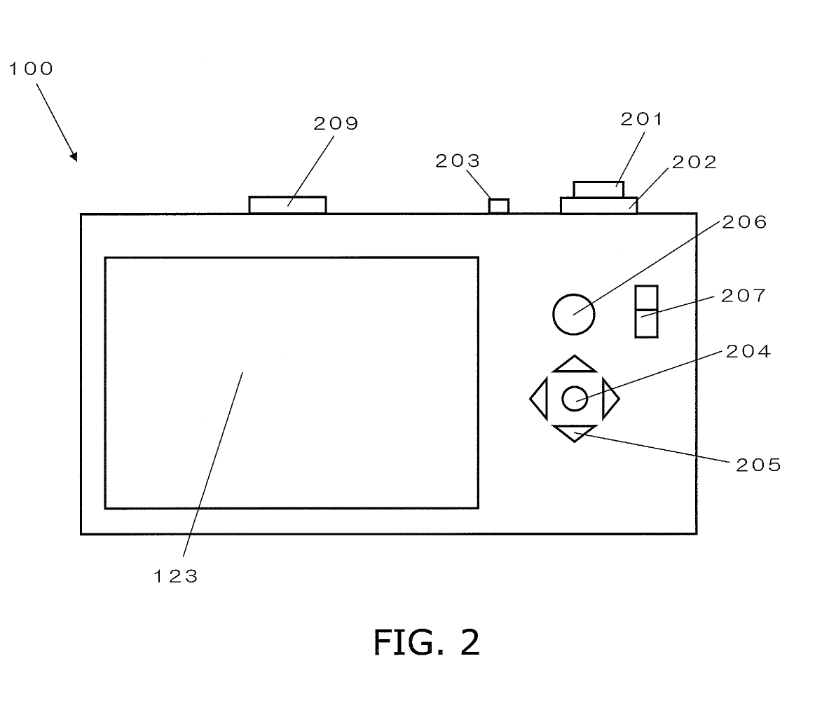

As shown in FIG. 2, the digital camera 100 is provided with the above manipulation unit 150 on its rear face. The above manipulation unit 150 further includes a liquid crystal monitor 123, a cross key 205, a moving picture release button 206, a mode switch 207, and so on.

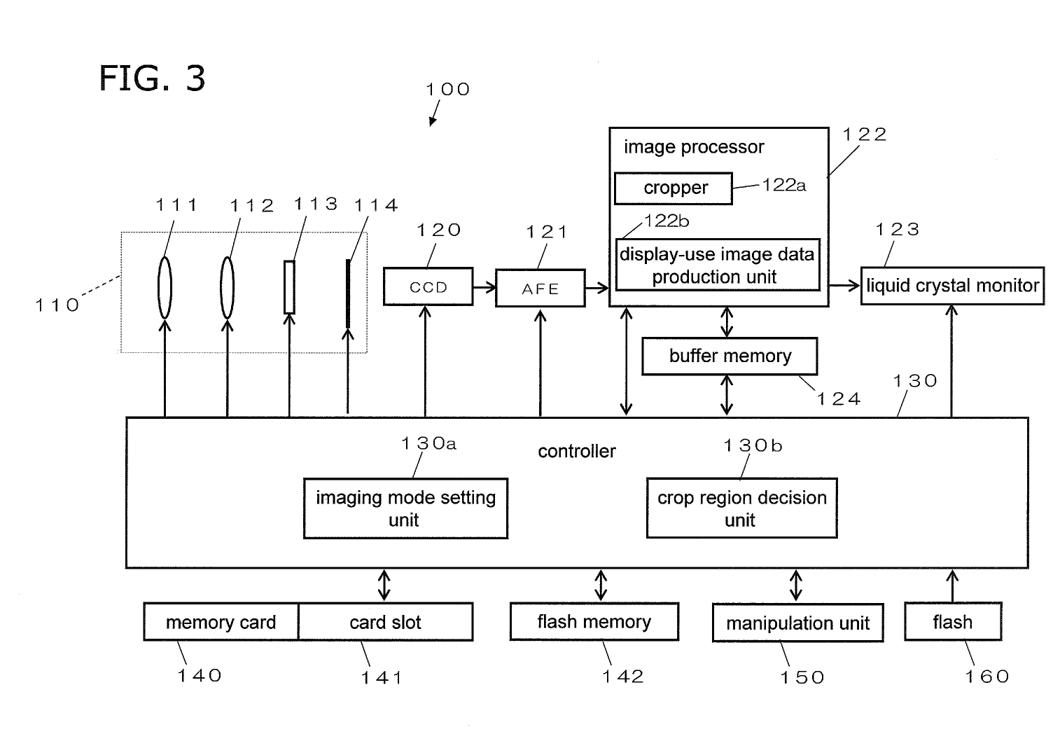

As shown in FIG. 3, the digital camera 100 comprises the optical system 110, a CCD image sensor 120, an AFE (analog front end) 121, an image processing unit 122, a buffer memory 124, the liquid crystal monitor 123, a controller 130, a card slot 141, a memory card 140, a flash memory 142, the manipulation unit 150, and the flash 160.

The optical system 110 forms a subject image. The optical system 110 has a focus lens 111, a zoom lens 112, an aperture 113, and a shutter 114. In another embodiment, the optical system 110 may include an optical shake correcting lens which functions as OIS (optical image stabilizer). Also, the lenses included in the optical system 110 may each be constituted by a number of lenses, or may be constituted by a number of groups of lenses.

The focus lens 111 is used to adjust the focal state of the subject. The zoom lens 112 is used to adjust the angle of field of the subject. The aperture 113 is used to adjust the amount of light which is incident on the CCD image sensor 120. The shutter 114 is used to adjust the exposure time with incident light on the CCD image sensor 120. The focus lens 111, the zoom lens 112, the aperture 113, and the shutter 114 are each driven by drive unit such as a DC motor, stepping motor, or other according to a control signal issued from the controller 130.

The CCD image sensor 120 is an imaging element that captures the subject image formed by the optical system 110. The CCD image sensor 120 produces a frame of image data depicting the subject image.

The AFE (analog front end) 121 subjects the image data produced by the CCD image sensor 120 to various processing. More specifically, the AFE 121 performs noise suppression by correlated double sampling, amplification to the input range width of an A/D converter by analog gain controller, A/D conversion by A/D converter, and other such processing.

The image processing unit 122 subjects the image data that has undergone various processing by the AFE 121 to various other processing. The image processing unit 122 subjects the image data to smear correction, white balance correction, gamma correction, YC conversion processing, electronic zoom processing, compression processing, reduction processing, enlargement processing, and other such processing. The image processing unit 122 produces a through-image (through-the-lens image) and a recorded image by performing the above processing on the image data. In this embodiment, the image processing unit 122 is a microprocessor that executes programs. In another embodiment, however, the image processing unit 122 may be a hard-wired electronic circuit. The image processing unit 122 may also be integrally constituted with the controller 130 and so forth.

The image processing unit 122 executes the processing of a cropping unit 122a and the processing of a display image data production unit 122b on the basis of commands from the controller 130. When a reduced image needs to be produced, the image processing unit 122 executes the processing of a reduced image data production unit 122c on the basis of a command from the controller 130. The processing of the cropping unit 122a, the processing of the display image data production unit 122b, and the processing of the reduced image data production unit 122c will be discussed below in detail.

The controller 130 controls the overall operation of the entire digital camera 100. The controller 130 is composed of a ROM, a CPU, etc. In the ROM are stored programs related to file control, auto focus control (AF control), automatic exposure control (AE control), and light emission control over the flash 160, as well as programs for the overall control of the operation of the entire digital camera 100.

The controller 130 controls an imaging condition mode setting unit 130a and a crop region decision unit 130b by having the CPU execute the programs stored in the ROM. The operation of the imaging condition mode setting unit 130a and the crop region decision unit 130b will be discussed below in detail.

The controller 130 records image data that has undergone various processing by the image processing unit 122 as still picture data or moving picture data to the memory card 140 and the flash memory 142 (hereinafter referred to as the “memory card 140, etc.”). In this embodiment, the controller 130 is a microprocessor that executes programs, but may instead be a hard-wired electronic circuit. The controller 130 may also be integrally constituted with the image processing unit 122 and so forth.

The liquid crystal monitor 123 displays through-images, recorded images, and other such images. The through-images and recorded images are produced by the image processing unit 122. The through-images are a series of images produced continuously at specific time intervals while the digital camera 100 is set to imaging mode. More precisely, a series of image data corresponding to a series of images is produced by the CCD image sensor 120 at specific time intervals. The user can capture an image while checking the subject composition by referring to the through-image displayed on the liquid crystal monitor 123.

The recorded images are obtained by decoding (expanding) still picture data or moving picture data which is recorded to the memory card 140, etc. Recorded images are displayed on the liquid crystal monitor 123 when the digital camera 100 is set to reproduction mode. In another embodiment, an organic EL display, a plasma display, or any other such display configured to display images may be used in place of the liquid crystal monitor 123.

The buffer memory 124 is a volatile storage medium that functions as the working memory for the image processing unit 122 and the controller 130. In this embodiment, the buffer memory 124 is a DRAM.

The flash memory 142 is an internal memory of the digital camera 100. The flash memory 142 is a non-volatile storage medium. The flash memory 142 has a customized category registration region and a current value holding region (not shown).

The memory card 140 is inserted into and removed from the card slot 141. The card slot 141 is connected electrically and mechanically to the memory card 140.

The memory card 140 is an external memory of the digital camera 100. The memory card 140 is a non-volatile storage medium.

The manipulation unit 150 is a manipulation interface that handles user operations. The manipulation unit 150 is a generic term for all the buttons, dials, and so forth disposed on the outer housing of the digital camera 100. The manipulation unit 150 includes the still picture release button 201, the moving picture release button 206, the zoom lever 202, the power button 203, a center button 204, the cross key 205, and the mode switch 207. Upon receiving a user operation, the manipulation unit 150 immediately sends the controller 130 a signal corresponding to the operation.

The still picture release button 201 is a push-button-type switch for designating the timing to record still picture. The moving picture release button 206 is a push-button-type switch for designating the timing to start and stop moving picture. The controller 130 directs the image processing unit 122 and so forth to produce still picture data or moving picture data according to the timing at which the release buttons 201 and 206 are pressed, and this data is stored in the memory card 140, etc.

The zoom lever 202 is a lever for adjusting the angle of field between the wide angle side and the telephoto side. The controller 130 drives the zoom lens 112 according to user operation of the zoom lever 202.

The power button 203 is a sliding-type switch for switching the power on and off to the various units of the digital camera 100.

The center button 204 and the cross key 205 are push-button-type switches. The user manipulates the center button 204 and the cross key 205 to display various setting screens (including setting menu screens and quick setting menu screens that are not shown) on the liquid crystal monitor 123. The user can set the item values related to various imaging conditions and reproduction conditions on these setting screens.

The mode switch 207 is a sliding-type switch for switching the digital camera 100 between imaging mode and reproduction mode.

The scene switching dial 209 is a dial for switching the scene mode. “Scene mode” is a generic term for the mode that is set according to the recording condition. Factors that affect the recording condition include the subject, the recording environment, and so on. The scene switching dial 209 is used to set any one of a plurality of scene modes.

The plurality of scene modes include, for example, landscape mode, portrait mode, nighttime mode, shake-correctable nighttime mode, and scene determination mode. The “shake-correctable nighttime mode” (handheld nighttime mode) is a mode in which the user captures an image in a state of low ambient light, without putting the digital camera 100 on a tripod or other fixing device.

Here, when the scene determination mode is selected, any one of landscape mode, portrait mode, nighttime mode, and handheld nighttime mode, for example, is set automatically on the basis of image data.

1-2. Operation in Imaging Mode

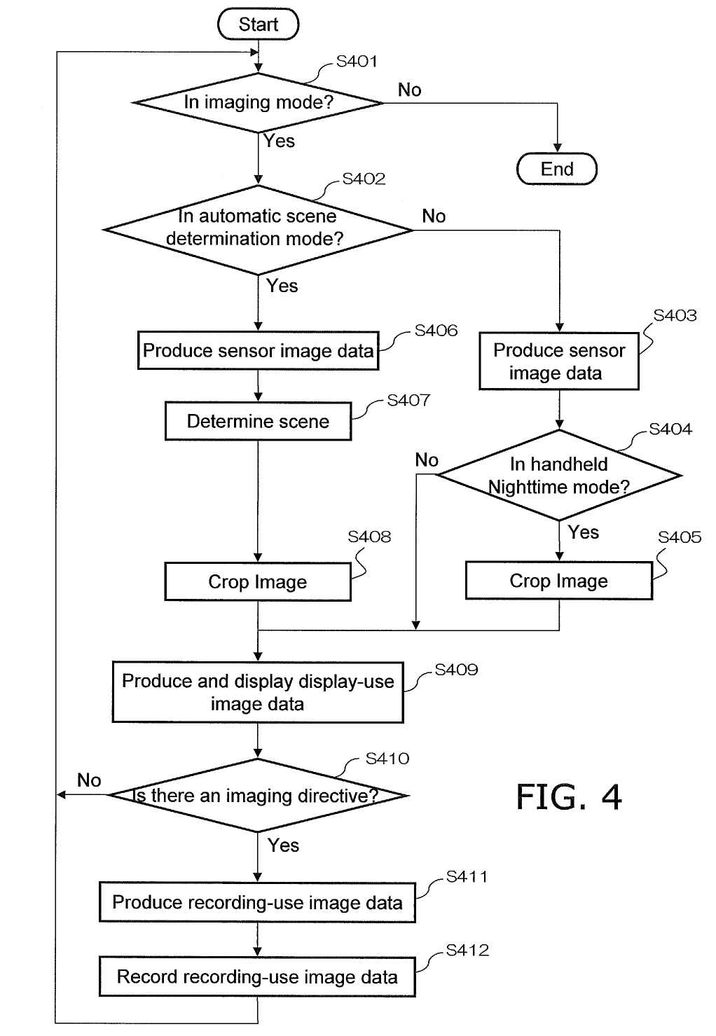

The operation in imaging mode will now be described through reference to FIG. 4.

When the user switches on the power to the digital camera 100 with the power button 203, the controller 130 refers to the setting of the mode switch 207 (S401). More precisely, the controller 130 determines whether the setting on the mode switch 207 is imaging mode or reproduction mode. If the mode switch 207 has been set to the reproduction mode (No in S401), the controller 130 ends processing related to the imaging mode.

If the mode switch 207 has been set to the imaging mode (Yes in S401), the controller 130 refers to the scene mode which is set by the manipulation unit 150 (S402). More precisely, the controller 130 determines whether or not the scene mode is the scene determination mode.

Let us now describe the scene mode. A scene mode is selected from among a plurality of scene modes which are registered in the digital camera 100. For instance, if the user operates the manipulation unit 150 to select a mode other than the scene determination mode, the scene mode selected here is recognized by the controller 130. More specifically, any one of landscape mode, portrait mode, nighttime mode, handheld nighttime mode, and so forth is selected by the user and recognized by the controller 130. On the other hand, if the user operates the manipulation unit 150 to select the scene determination mode, then the controller 130 automatically selects any one of landscape mode, portrait mode, nighttime mode, handheld nighttime mode, and so forth.

If the scene mode is the scene determination mode (Yes in S402), the controller 130 recognizes the image data which is produced by the CCD image sensor 120 (sensor image data) (S406). The controller 130 then performs automatic scene determination on the basis of the sensor image data (S407). As a result of this automatic scene determination, the controller 130 automatically selects and sets the best mode which suites to the current situation from among a plurality of scene modes, such as landscape mode, portrait mode, nighttime mode, and handheld nighttime mode.

Then, the image processing unit 122 executes processing to crop part of the sensor image data (S408). For instance, the controller 130 sets the crop region corresponding to the angle of field which is set in the handheld nighttime mode. The image processing unit 122 then executes processing for cropping the image data in this crop region, and outputs the image data of this crop region as cropped image data. After this, the image processing unit 122 reduces the cropped image data to a specific size (for example, a specific resolution such as specific pixel count) on the basis of a command from the controller 130, and produces display image data. A through-image is then displayed on the liquid crystal monitor 123 on the basis of this display image data (S409).

For instance, if the sensor image data is raw data, the cropped image data cropped from the sensor image data is smaller in size than the sensor image data, but the cropped image data is raw data. Thus handling the image data as raw data allows degradation of image quality to be kept to a minimum. This cropped image data (raw data) is then reduced to produce display image data of a size corresponding to the screen resolution.

Here, if the user has pressed the still picture release button 201, the controller 130 detects that the still picture release button 201 has been pressed (S410). The image processing unit 122 then produces recording image data (recording-use image data) with the cropped image data on the basis of a command from the controller 130 (S411). The recording image data is image data for recording (a recording-use image data). The controller 130 then executes processing for recording the recording image data to a recording unit, such as the memory card 140 (S412). After this, the controller 130 again executes processing for referring to the mode (imaging mode or reproduction mode) which is set with the mode switch 207 (S401). The above series of operations is repeatedly executed until either the mode switch 207 changes to reproduction mode (No in S401) or the power is shut off.

If the above-mentioned processing (processing in the case of “Yes in S402”) have been executed, such as if the scene mode has been set to scene determination mode, the sensor image data is partially cropped (see S408). Specifically, in the scene determination mode, regardless of whether or not the automatically determined scene mode is handheld nighttime mode, the sensor image data is cropped as the cropped image data using the angle of field of the handheld nighttime mode. This cropped image data is then used so that a through-image with the same angle of field is always displayed on the liquid crystal monitor 123.

Consequently, in scene determination mode, the image can always be displayed at a constant angle of field on the liquid crystal monitor 123 even if the scene mode has been automatically switched. Specifically, in scene determination mode, even if the scene mode has been switched, such as “from handheld nighttime mode to mode other than handheld nighttime mode, to handheld nighttime mode, to mode other than handheld nighttime mode,” a natural-looking image that does not appear to flicker can still be displayed on the liquid crystal monitor 123.

The processing for cropping the cropped image data from the sensor image data is executed as discussed above, but other processing is executed on the basis of the setting of each scene mode.

Meanwhile, if the scene mode has been set to mode other than the scene determination mode (No in S402), the controller 130 recognizes the sensor image data (S403). The controller 130 then determines whether or not the current scene mode is the handheld nighttime mode (S404).

If the current scene mode is set to the handheld nighttime mode (Yes in S404), then just as in step 408 (S408), the image processing unit 122 executes processing to crop part of the sensor image data (S405). For instance, the image processing unit 122 outputs the sensor image data in the crop region set by the controller 130 as cropped image data. After this, the image processing unit 122 reduces the cropped image data to a specific size (for example, a specific resolution such as a specific pixel count) on the basis of a command from the controller 130, and produces display image data. A through-image is then displayed on the liquid crystal monitor 123 on the basis of this display image data (S409).

If the current scene mode has been set to mode other than the handheld nighttime mode (No in S404), the image processing unit 122 produces display image data with the sensor image data. In this case, the controller 130 does not execute crop processing on the image data. When display image data is produced in this manner, this display image data is displayed as a through-image on the liquid crystal monitor 123 (S409).

If the scene mode is mode other than the scene determination mode (No in S402), the processing from step 410 (S410) to step 412 (S412) is executed just as above. When the processing of step 412 (S412) ends, the processing of step 401 (S401) is executed again. Also, the above-mentioned series of operations is repeated until either the mode switch 207 changes to reproduction mode (No in S401) or the power is shut off.

In the processing discussed above (processing in the case of “No in S402”), the sensor image data is partially cropped (see S405) if the scene mode is the handheld nighttime mode (see “Yes in S404”). In contrast, if the scene mode is mode other than the handheld nighttime mode (see “No in S404”), the sensor image data is not cropped. Accordingly, the angle of field of the display image data in case of the handheld nighttime mode is different from the angle of field of the display in case of another mode. Specifically, although the same subject is imaged, a different through-image will be produced depending on whether or not the scene mode is the handheld nighttime mode. This difference occurs with a recorded image as well. In this case (No in S402), however, the scene mode is not automatically switched as in the above case (Yes in S402), so the image does not appear to flicker.

1-3. Features

This technology can provide an imaging device configured to display a natural-looking image.

In the above embodiment, when the scene mode is the handheld nighttime mode, the crop position during exposure is changed, and the cropping of image data is executed in a region which is smaller than the entire region for the sensor image data. Also, the cropping of image data is executed before the production of the display image data and the recording image data. Consequently, less noise is generated when there is little light and a longer exposure time is necessary.

Also, in the above embodiment, if the scene mode is the scene determination mode, regardless of whether or not the automatically determined scene mode is handheld nighttime mode, the sensor image data is cropped as the cropped image data using the angle of field of the handheld nighttime mode as a reference. This cropped image data is then used to produce display image data, so that a natural-looking through-image is always displayed on the liquid crystal monitor 123.

Furthermore, in the above embodiment, when the scene mode is set manually, once the scene mode has been set, it will not be switched automatically. Accordingly, even if the above-mentioned series of operations is executed once at specific time intervals (such as 1/30 second) in a state in which the still picture release button 201 has not been pressed, a natural-looking through-image that does not appear to flicker can be displayed on the liquid crystal monitor 123.

### Other Embodiments

An embodiment of the present technology was described above, but the present technology is not limited to or by the above embodiment, and various changes are possible without departing from the gist of the technology. In particular, embodiments and modification examples given in this Specification can be combined as needed.

The following is an example of another embodiment.

In the above embodiment, if the scene mode was handheld nighttime mode as a result of the automatic scene determination (S407) the image processing unit 122 produces a display image with the cropped image data in step 409 (S409), the display image is displayed on the liquid crystal monitor 123. Instead of this, dummy image data may be added around the cropped image data, the image processing unit 122 may produce a display image on the basis of the cropped image data to which the dummy image data has been added, and this product may be displayed on the liquid crystal monitor 123. The same effect as in the above embodiment can be obtained when this processing is executed.

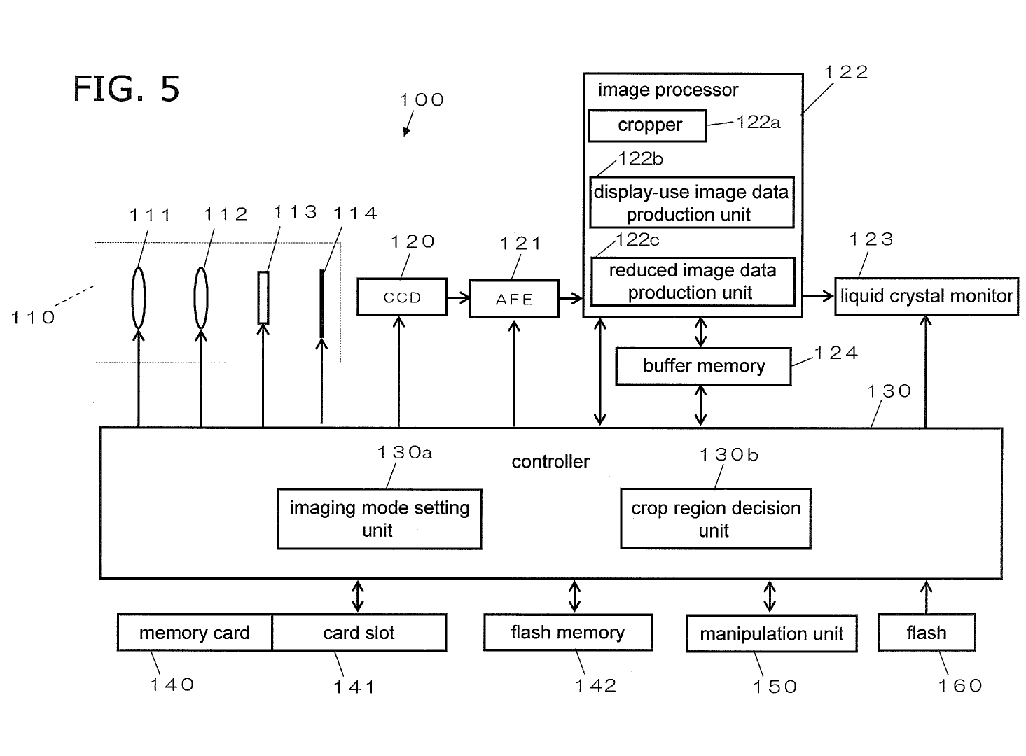

Also, in the above embodiment, after the scene was automatically determined (S407) on the basis of sensor image data, the cropped image data is cropped on the basis of a crop region corresponding to the angle of field set in the handheld nighttime mode in step 408 (S408). Instead of this, after step 407 (S407), processing to reduce the sensor image data may be executed by the controller 130 so that reduced image data is outputted. This processing is executed by the reduced image data production unit 122c shown in FIG. 5. The reduced image data production unit 122c is controlled by the controller 130 on the basis of programs stored in the ROM.

In this case, in step 408 (S408) the controller 130 sets the crop region of reduced image data corresponding to the angle of field set for the handheld nighttime mode. Next, the controller 130 outputs the reduced image data for this crop region as cropped image data. The same effect as in the above embodiment can be obtained by executing this processing.

The following embodiments may be employed in addition to the other embodiment given above.

In the above embodiment, the sensor image data is subjected to crop processing. However, the image data that undergoes cropping is not limited to the sensor image data itself, and may be other image data related to the sensor image data. For instance, the sensor image data may be subjected to thinning processing which thins the amount of information, or to superposition processing or other such processing. Also, crop processing may be performed on a recording image or on a display image produced via the image processing unit 122.

In the above embodiment, in the scene determination mode, if the scene mode is set to mode other than the handheld nighttime mode, the same crop processing as in the handheld nighttime mode is always performed on the sensor image data. Specifically, in the above embodiment, the display image data and the recording image data are cropped at the same angle of field on the basis of the sensor image data. The reason for executing this crop processing is to match the angle of field of a display notifying the user through the liquid crystal monitor 123 with the angle of field of a recorded image. However, if this matching is not necessary, the crop processing may be performed on just the display image data or the recording image data. For example, when the goal is just to suppress flicker, then crop processing may always be performed on just the display image data.

In the above embodiment, the recording image data actually stored in the memory card 140 is produced by the image processing unit 122 on the basis of sensor image data produced by the CCD image sensor 120, or cropped image data that has been cropped from this sensor image data. The recording image data is YC image data, for example. The recording image data does not necessarily have to be YC image data, though, and may instead be other image data related to sensor image data or cropped image data. For instance, the recording image data may be image data compressed in JPEG format in order to improve recording efficiency. Also, the recording image data may be the sensor image data itself, or the cropped image data itself.

In the above embodiment, crop processing for the purpose of producing a still picture is executed in normal operation in imaging mode, or when the still picture release button 201 is pressed. However, what is to be cropped is not limited to a still picture, and may be a moving picture, for example. For instance, when a scene is automatically determined during the recording of a moving picture, cropping may always be executed on the moving picture data.

In the above embodiment, an example was given of a case in which display image data was produced by reducing cropped image data to a specific size, but display image data may instead be produced by enlarging the cropped image data to a specific size. For instance, if the resolution of the cropped image data cropped from the sensor image data in S408 of FIG. 4 is lower than the resolution of the display image data, then in S409 the image processing unit 122 interpolates the missing pixel data on the basis of pixel data for the cropped image data. This increases the resolution of the cropped image data to a specific level. When this is done, display image data is produced in a size corresponding to the screen resolution.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of imaging device. Accordingly, these terms, as utilized to describe the present invention should be interpreted relative to imaging device.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

### INDUSTRIAL APPLICABILITY

The present technology can be used in imaging devices.

What is claimed is:

1. An imaging device comprising:
an imaging unit configured to capture an image of a subject and generate image data;
an imaging condition mode setting unit configured to automatically select and set any one of a plurality of imaging condition modes based on the image data;
a crop region decision unit configured to decide a region of the image data to be cropped according to the imaging condition mode selected and set by the imaging condition mode setting unit, the region to be cropped being characterized as a crop region;
a cropping unit configured to remove the crop region from the image data, the crop region removed from the image data being characterized as cropped image data;
a display image data production unit configured to generate display image data of the cropped image data, the display image data being set to a specific size; and
a display unit configured to display an image based on the display image data.

2. The imaging device according to claim 1, wherein
at least one of the imaging condition modes has a specific angle of field, the crop region decision unit being further configured to decide the crop region that corresponds to the specific angle of field.

3. The imaging device according to claim 1, wherein
the display image data is generated by increasing or decreasing the cropped image data to a specific size.

4. The imaging device according to claim 1, further comprising
a reduced image data production unit configured to execute a reduction process on the image data to generate reduced image data , wherein
the crop region decision unit is configured to decide a region of the reduced image data to be cropped according to the imaging condition mode selected and set by the imaging condition mode setting unit, the region of the reduced image data to be cropped being characterized as the crop region, and
the cropping unit is configured to remove the crop region from the reduced image data decided by the crop region decision unit, the crop region removed from the reduced image data being characterized as the cropped image data.

5. The imaging device according to claim 1, wherein
the display image data production unit is configured to execute a reduction process and/or an enlargement process on the cropped image data to generate the display image data.

6. The imaging device according to claim 1, wherein
the display image data production unit is configured to generate the display image data by maintaining the size of the cropped image data, and
dummy image data, which is stored in a memory unit, is added around the cropped image data.
